(19) United States
(12) Patent Application Publication
(10) Pub. No.: US 2011/0029572 A1
(43) Pub. Date: Feb. 3, 2011

(54) DATA PROCESSING SYSTEM AND METHOD OF CONTROLLING THE SYSTEM

(75) Inventor: Junji Sato, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/828,583

(22) Filed: Jul. 1, 2010

(30) Foreign Application Priority Data
Jul. 31, 2009 (JP) 2009-180049

(51) Int. Cl. G06F 17/30

(52) U.S. Cl. 707/802; 707/E17.005

(57) ABSTRACT

The present invention relates to a data processing system and method of controlling the system which store job histories of jobs executed on a data processing apparatus. A database stores job attribute data and content data of jobs executed on the data processing apparatus as well as retention dates set for the job attribute data and content data. The database determines the content data to be deletable if data serving as the basis of the content data has been deleted on the data processing apparatus, and deletes the content data upon expiration of its retention date.

### BACKGROUND OF THE INVENTION

1. Field of the Invention

The present invention relates to a data processing system and method of controlling the system, which record job histories of jobs executed on a data processing apparatus and allow the job histories to be searched for, the job histories respectively including information on users of the jobs and execution date/time of the jobs.

2. Description of the Related Art

Recently, it has become easy for anyone to print, copy, fax, or e-email originals using a digital multi function peripheral. While user convenience is improved in this way, leakage of confidential documents through printing, copying, fax, or e-email has become a problem. To deal with this problem, some digital multi function peripherals store a job history in a database when a job such as printing, copying, faxing, or e-email transmission is executed. A job history generally contains job attribute data such as user information about the user who executed the job, date/time information about the execution date/time of the job, and the type of the executed job as well as content data such as image data and/or text data processed in the job.

A job history audit system which creates and manages such job histories includes a digital multi function peripheral and server. The server includes a database and stores job history acquired by the digital multi function peripheral in the database by receiving the job history from the digital multi function peripheral. The job histories are stored in the database for a predetermined period of time and allowed to be searched for. This allows job execution information to be traced back in case any leakage of information is discovered. Such a job history audit system stores a large number of job histories, requiring a high-capacity storage device. Thus, methods have been proposed which store a larger number of job histories efficiently by reducing amounts of data to be stored.

According to a technique described in Japanese Patent Laid-Open No. 2006-330939, when a job is executed by an image processing apparatus, if the same content data as that of the job is already stored in a database, reference information pointing to the content data existing in the database is stored instead of the content data of the job. This is intended to reduce storage capacity requirements of the database. Specifically, the image processing apparatus records the content data of an inputted job when executing the inputted job, and records reference information pointing to existing content data when executing an output job which uses the existing content data.

The method described in Japanese Patent Laid-Open No. 2006-330939 will be described in more detail. The digital multi function peripheral contains an area used to store document data in the system. This area is called, for example, a user box. Consequently, even if there is no data at hand of a user, the user can do printing or transmit e-mail using the document data stored in the user box. In this case, an input job is intended to store document data in the user box, and an output job uses the document data stored in the user box, so it is the common document data that is processed by both input job and output job. Therefore, it is redundant to store content data of the input job and output job as job histories in the database when the respective jobs are executed. Thus, job content data is stored in the database only when the input job is executed, and only reference information pointing to the content data in the database is stored when the output job is executed. This reduces the amount of data of job history stored in the database.

However, the method described in Japanese Patent Laid-Open No. 2006-330939 has a problem in that since an output job involves recording the reference information pointing to the content data, if the content data referred to is deleted, it becomes impossible to check contents of the output job.

The job history audit system generally stores job histories for a given time period, allowing the job histories to be searched for in the given time period. However, since there is a limit to the capacity of the database, the job histories which have passed a set period of time are deleted from the database on the premise that the job histories will be saved in a medium, such as magnetic tape, suitable for long storage. With such a job history audit system, if content data of an input job is stored first and reference information for an output job is stored later, there can be a difference in the retention date in the database between the content data and reference information pointing to the content data. Consequently, if the content data (whose retention date is earlier than that of the output job) of the input job is deleted first from the database, it subsequently becomes impossible to acquire the content data based on the reference information for the output job.

To deal with this problem, the retention dates of job attribute data and content data are managed separately, and when the job history of the output job is stored in the database, the retention date (for example, the retention date of the input job of the job) of the content data referred to is updated. This avoids inconsistency in retention dates between the content data of the input job and reference information for the output job.

However, with this method, if the retention date of the input job is reached before any output job of the input job is generated, the content data of the input job is deleted from the database. This causes a problem in that when an output job is generated subsequently, the content data of the input job cannot be referred to in the job history of the output job.

### SUMMARY OF THE INVENTION

An aspect of the present invention is to eliminate the above-mentioned problems with the conventional technology.

It is a feature of the present invention to prevent content data of an input job from being deleted from a database even if the retention date of the input job is reached before any corresponding output job is generated.

According to an aspect of the present invention, there is provided a data processing system which enables storing content data in a database as a job history of a job executed on a data processing apparatus, the content data representing contents of data related to the job, the data processing system comprising: a job history storage unit configured to store the content data in the database with a retention date of the content data; a determination unit configured to determine that the content data stored in the database is deletable if data corresponding to the content data has been deleted on the data processing apparatus; and a deletion unit configured to delete the content data determined by the determination unit to be deletable, when the retention date of the content data passes.

According to another aspect of the present invention, there is provided a method of controlling a data processing system which includes a database connected with a data processing apparatus via a network and enables storing content data in the database as a job history of a job executed on the data processing apparatus, the content data representing contents of data related to the job, the control method comprising: storing the content data with a retention date of the content data; determining that the content data stored in the database is deletable if data serving as the basis of the content data has been deleted on the data processing apparatus; and deleting the content data determined in the determining step to be deletable, when the retention date of the content data passes.

Further features and aspects of the present invention will become apparent from the following description of exemplary embodiments, with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a configuration diagram of a job history audit system according to an exemplary embodiment;

FIGS. 2A and 2B are block diagrams describing configurations of a digital multi function peripheral, servers, and a database;

FIG. 3 is a flowchart describing a job history storage process of the digital multi function peripheral according to a first embodiment;

FIGS. 4A and 4B are diagrams describing various jobs executed by the digital multi function peripheral, classification of the jobs into input jobs and output jobs, content data, and job histories, according to the first embodiment;

FIGS. 5A and 5B are diagrams describing a concrete example of job histories stored in the database according to the first embodiment;

FIG. 6 is a flowchart describing a job history deletion process in the database according to the first embodiment;

FIG. 7 is a diagram describing the processes of S704 to S706 in FIG. 6 according to the first embodiment;

FIG. 8 is a flowchart describing the process of changing a retention date of content data in a database according to the first embodiment;

FIG. 9 is a flowchart describing a deletion process according to a second embodiment; and

FIG. 10 is a diagram describing a content data deletion process according to the second embodiment.

### DESCRIPTION OF THE EMBODIMENTS

Embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

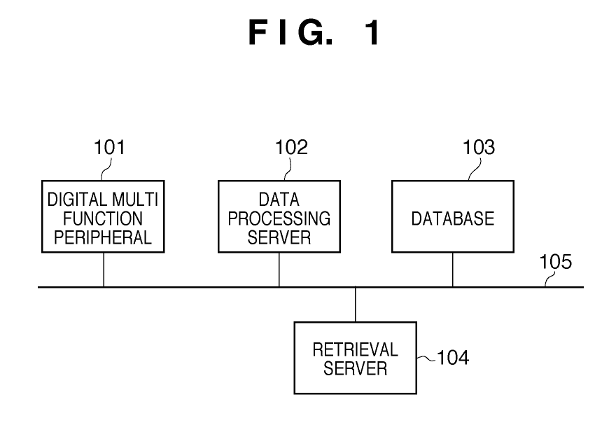

FIG. 1 is a configuration diagram of a job history audit system (data processing system) according to an exemplary embodiment of the present invention. In this example, a digital multi function peripheral 101 (which is an example of the data processing apparatus), data processing server 102, database 103, and retrieval server 104 are interconnected via a network 105.

The digital multi function peripheral 101 has capabilities to execute various jobs such as scanning, printing, copying, e-email transmission, and faxing. Also, the digital multi function peripheral 101 contains a storage area used to store document data in the system and has capabilities to print, e-mail, and fax the stored document data. According to the present embodiment, the storage area is called a box.

The digital multi function peripheral 101 also has capabilities to record job histories of various jobs executed on the digital multi function peripheral 101 and transmit the job histories to the data processing server 102. The job history contains job attribute data such as user information about the user who executed the job, date/time information about the execution date/time of the job, and the type of the executed job as well as content data on contents of document data (such as image data and/or text data) processed in the job.

The data processing server 102 performs a data conversion process on the job history received from the digital multi function peripheral 101 and stores the job history in the database 103. The data conversion process involves formatting the contents of the job attribute data contained in the job history, extracting text data from image data of the content data via an OCR process, and/or converting format and size of the image data. The conversion of size and the like has the effect of reducing a volume of content data, and thus an amount of data stored in the database 103. However, the content data may be stored as it is without a data conversion process. The data processing server 102 stores the job attribute data and content data as a job history in the database 103 by associating them with each other and setting a predetermined retention date. The database 103 stores the job history by receiving it from the data processing server 102. The job history is stored in the database 103 until the retention date specified by the data processing server 102 is reached, and can be searched for by the retrieval server 104 all this while. The database 103 may be any storage device that can store job histories, and may be, for example, a file server. The job histories stored in the database 103 are deleted one after another when their respective retention dates are reached.

When search conditions are received from a user, the retrieval server 104 retrieves one or more job histories which match the search conditions from the database 103 and presents the retrieved job histories to the user. The search conditions include, for example, job attributes such as a job owner and job execution date/time as well as a character string contained in text data, and are used to search the database 103 for a job history. The network 105 interconnects the digital multi function peripheral 101, data processing server 102, database 103, and retrieval server 104.

Although in FIG. 1, the network 105 is connected with one each of components ranging from the digital multi function peripheral 101 to the retrieval server 104, multiple units of each component may be connected alternatively. Also, different types of component may be included in the same server. For example, a single server may combine the retrieval server 104 and data processing server 102.

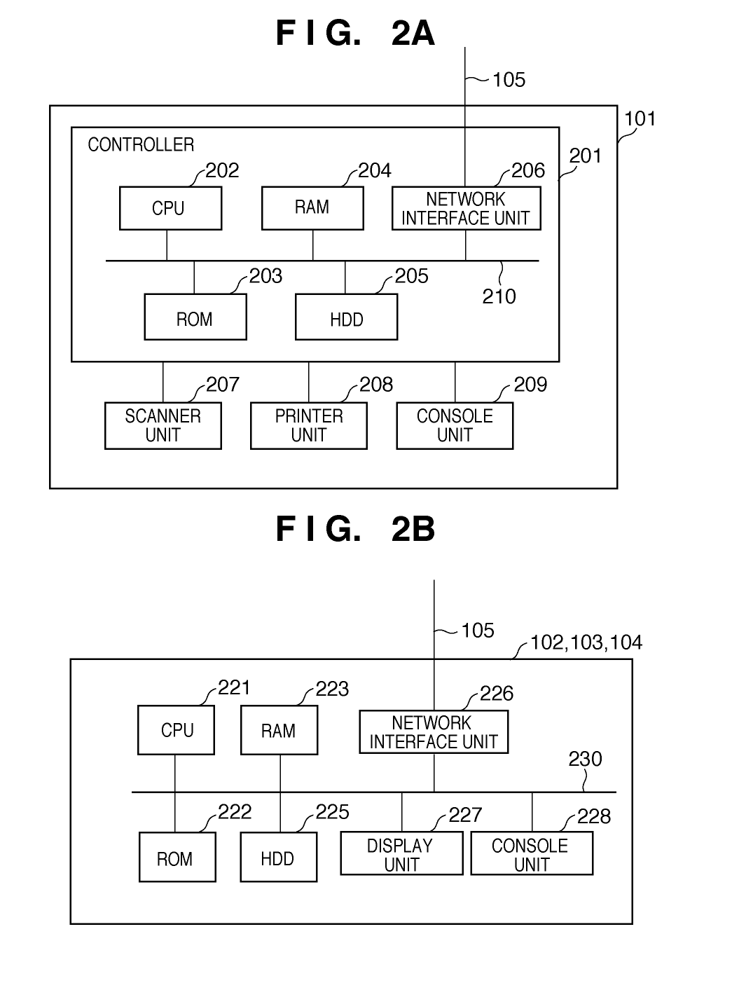

FIG. 2A is a block diagram describing a configuration of the digital multi function peripheral 101 according to the exemplary embodiment.

A controller 201 is connected to a scanner unit 207, printer unit 208, and console unit 209. Also, the controller 201 is connected to the network 105 via a network interface unit 206. In the controller 201, a CPU 202 controls the digital multi function peripheral 101 according to a program loaded into a RAM 204. A ROM 203 stores a boot program used to start the system. The RAM 204 loads a program from an HDD (hard disk drive) 205 in order for the CPU 202 to run according to the program. Besides, the RAM 204 is also used as a buffer memory to temporarily store inputted image data. The hard disk drive (HDD) 205 stores system software and job histories. Also, part of the HDD 205 is used as a box area to store document data. The document data includes data of documents and images as well as various application data. The network interface unit 206 is connected to the network 105 and used to exchange document data, job histories, information about the digital multi function peripheral 101, and the like with other devices on the network 105. The CPU 202, ROM 203, RAM 204, HDD 205 and the network interface unit 206 are placed on a system bus 210. The console unit 209 outputs information about the digital multi function peripheral 101 and information needed to operate the digital multi function peripheral 101 to a screen. Also, the console unit 209 accepts operator inputs and transmits information about the operator inputs to the controller 201.

FIG. 2B is a block diagram describing configurations of the data processing server 102, database 103, and retrieval server 104 according to the exemplary embodiment.

The data processing server 102, database 103, and retrieval server 104 are connected to the network 105 via a network interface unit 226. A CPU 221 controls the data processing server 102, database 103, or retrieval server 104 according to a program loaded into a RAM 223. A ROM 222 stores a boot program used to start the device. The RAM 223 loads a program from an HDD 225 in order for the CPU 221 to run according to the program. Besides, the RAM 223 also serves as a buffer memory to temporarily store various input data. The hard disk drive (HDD) 225 stores system software, job histories, and document data. The document data includes data of documents and images as well as various application data. The network interface unit 226 is connected to the network 105 and used to exchange information with other devices on the network 105. A display unit 227 displays messages to the user, various data, a UI screen, and the like. A console unit 228 includes a keyboard and pointing device and accepts user operations. The CPU 221, ROM 222, RAM 223, HDD 225, the network interface unit 226, the display unit 227 and the console unit 228 are placed on a system bus 230.

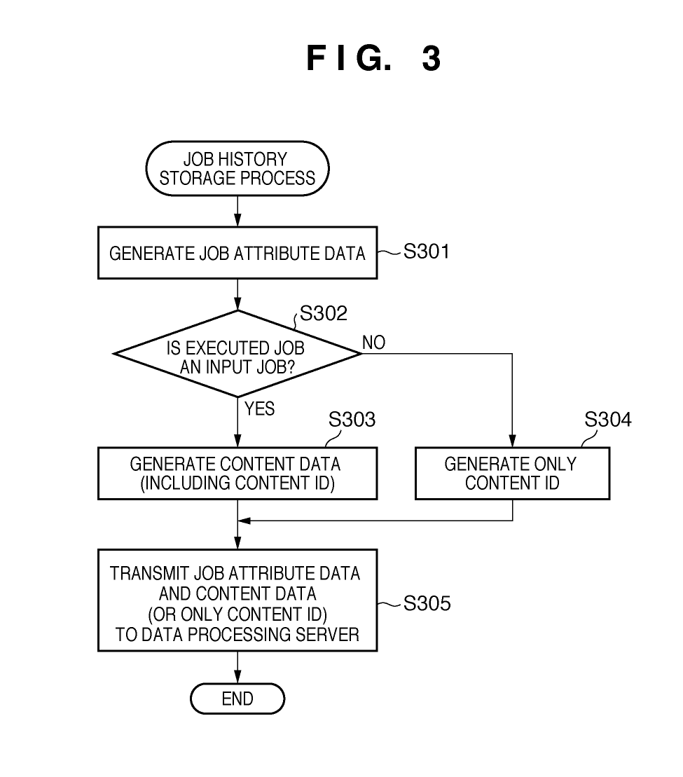

FIG. 3 is a flowchart describing a job history storage process performed by the digital multi function peripheral 101 according to a first embodiment. The job history storage process is performed when the digital multi function peripheral 101 executes a job. A program which performs this process is loaded in the RAM 204 during execution and executed under the control of the CPU 202.

First, in step S301, job attribute data of a job executed on the digital multi function peripheral 101 is generated, including information on the user who executed the job and execution date/time of the job. The job attribute data is generated by the CPU 202 and temporarily stored in the HDD 205. Next, in step S302, the CPU 202 determines whether the executed job is an input job or an output job. If it is determined that the job is an input job which involves inputting new document data, the process advances to step S303 to store content data of the input job and a content ID used to identify the content data, in the HDD 205. The content data is generated through data processing by the CPU 202 based on the document data of the input job from the network interface unit 206 or scanner unit 207 and temporarily stored in the HDD 205. The content data may be either generated by data processing based on the document data of the input job or duplicated from the document data of the input job as long as the content data represents contents of the document data of the input job. Besides, the content ID is stored in the HDD 205 also as attribute information which represents attributes of the document data.

On the other hand, if it is determined that the job executed by the digital multi function peripheral 101 is an output job which involves processing the document data inputted as a result of an input job, the process advances to step S304. In step S304, the CPU 202 stores, in the HDD 205, only the content ID (reference information) corresponding to the document data processed in the output job. After carrying out step S303 or S304, the process advances to step S305 to transmit the job attribute data, content data, and content ID stored in the HDD 205 to the data processing server 102 as a job history by associating them with each other. If the job executed by the digital multi function peripheral 101 is an output job, the job history does not contain content data. This eliminates the need for data processing which involves processing cost. Therefore, in step S305, the CPU 202 may transmit the job history of the output job to the database 103 rather than to the data processing server 102.

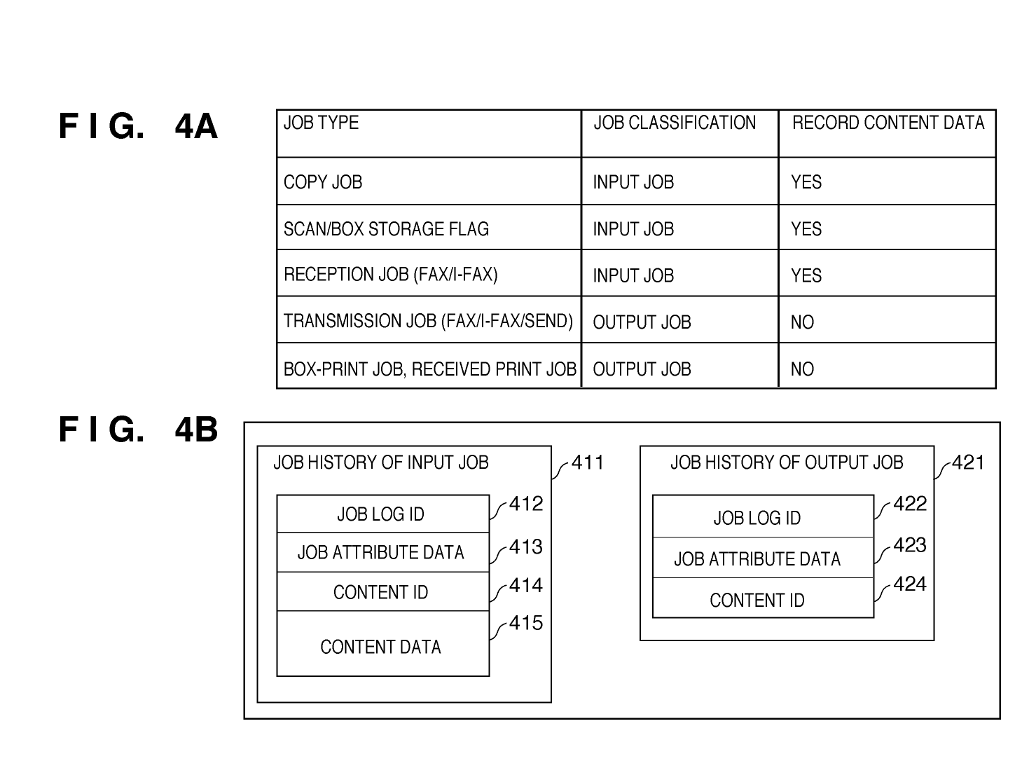

FIG. 4A is a diagram describing various jobs executed by the digital multi function peripheral 101 according to the first embodiment, classification of the jobs into input jobs and output jobs, and content data.

The input job involves processing a job inputted from outside. For example, a COPY job is an input job in which document data of an original read by the scanner unit 207 is inputted and printed by the printer unit 208. A SCAN/BOX storage job is an input job in which data of an original read by the scanner unit 207 is stored as document data in the box area of the HDD 205. A reception job (FAX/I-FAX) is an input job in which document data is received by the network interface unit 206 and stored in the HDD 205. When such an input job is executed, job attribute data and content data of the job are stored as a job history. Also, a content ID is assigned to the inputted document data to uniquely identify content data of the document data.

The output job involves processing document data inputted as an input job and held in the digital multi function peripheral 101. For example, a transmission job (FAX/I-FAX/SEND) is an output job in which data stored in the HDD 205 is transmitted by fax. A BOX-PRINT job is an output job in which document data stored in the user box area of the HDD 205 is printed by the printer unit 208. The document data used in the output job has been processed by some input job before. That is, the document data processed by the output job is the same one as processed by the input job. Therefore, the job history stored when an output job is executed by the digital multi function peripheral 101 includes the job attribute data of the output job as well as the content ID contained in the job history of the input job which has processed the same document data. Incidentally, the data (document data and job history and the like) stored in the HDD 205 is not deleted in response to an output command from the user. Consequently, when printing or faxing data, the digital multi function peripheral 101 can repeatedly output data once stored in the HDD 205. The data is deleted in response to a delete command from the user. Upon receiving a delete command from the user with data specified, the digital multi function peripheral 101 deletes the specified data from the HDD 205.

FIG. 4B is a diagram describing job histories generated by the digital multi function peripheral 101 according to the first embodiment.

In this example, it is assumed that a job history 411 of an input job and job history 421 of an output job are produced as a result of processing the same document data. The job history 411 of the input job contains a job log ID 412, job attribute data 413, a content ID 414, and content data 415. On the other hand, the job history 421 of the output job contains a job log ID 422, job attribute data 423, and a content ID 424. The job log ID uniquely identifies the job history. The content ID uniquely identifies the content data. The content ID is common among job histories, provided the jobs handled the same document data.

In this case, since the job history 411 of the input job and job history 421 of the output job are different job histories, the job log ID 412 and job log ID 422 differ from each other. Similarly, the job attribute data 413 and job attribute data 423 differ from each other in the job execution date/time and job type. On the other hand, since the job history 411 of the input job and job history 421 of the output job concern the same processed document data, the content ID 414 and content ID 424 coincide with each other.

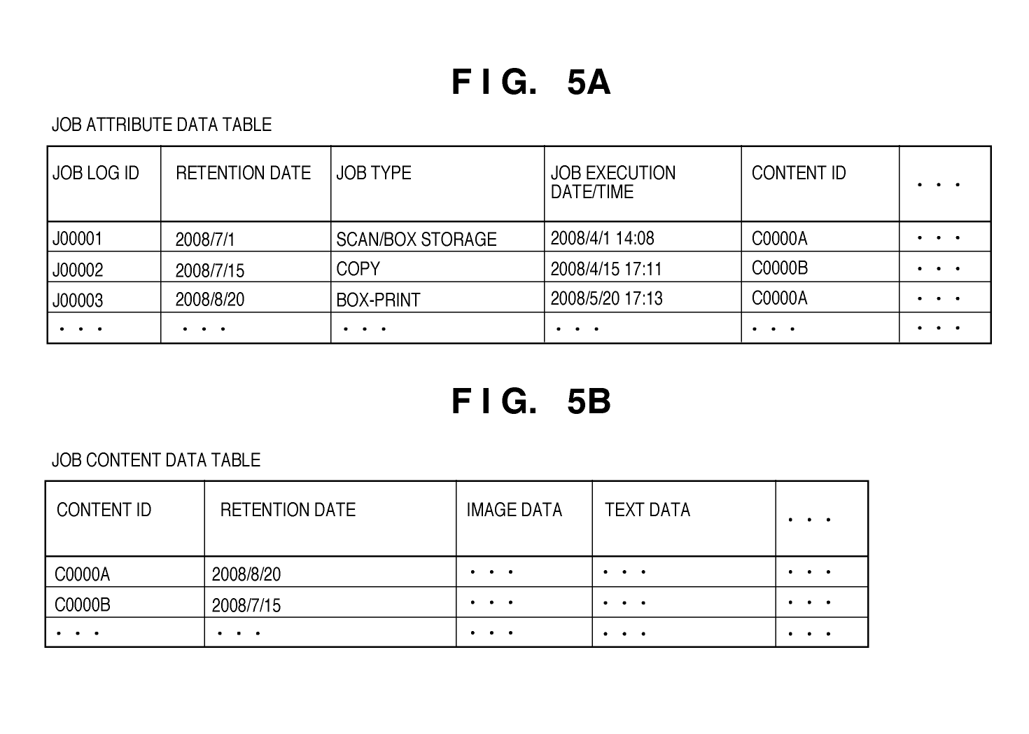

FIGS. 5A and 5B are diagrams describing a concrete example of job histories stored in the database 103.

A job attribute data table shown in FIG. 5A contains job attribute data including a job log ID, retention date, job type, job execution date/time, and content data ID, where the job log ID uniquely identifies a job and the content data ID identifies the content data processed in the job. A content data table shown in FIG. 5B contains a content ID and retention date as well as actual content data such as image data and text data, where the content ID uniquely identifies content data. The job attribute data shown in FIG. 5A and content data shown in FIG. 5B are associated with each other by the content ID.

In the example of FIGS. 5A and 5B, a job log ID “J00001” belongs to the job history of an input job while a job log ID “00003” belongs to the job history of an output job which processed the same document data as the input job whose job log ID is “J00001”. Although the two job histories differ in the job attribute data such as the job type and job execution date/time, since the same document data was processed, the two job histories have the same content ID “C0000A.”

Job attribute data with a job log ID of “J00001” is designated here as job 1, job attribute data with a job log ID of “J00002” is designated as job 2, and job attribute data with a job log ID of “J00003” is designated as job 3. Besides, content data with a content ID of “C0000A” is designated as content A and content data with a content ID of “C0000B” is designated as content B.

Job 1 and content A are stored in the database 103 as a single job history by being associated by the content ID (C0000A). In the meantime, a predetermined retention date is specified (in this example, the retention date expires after three months from the execution date/time of the job). In the example of FIG. 5A, job 1 with content A is executed on Apr. 1, 2008 and its retention date is set to Jul. 1, 2008 which comes after three months. Job 3 stored in the database on May 20, 2008 has a retention date of Aug. 20, 2008 which comes after three months. Both job 1 and job 3 have a content ID of “C0000A” and are associated with content A. However, the same retention date as job 1 is set for content A, which therefore is subject to deletion after Jul. 1, 2008. Consequently, when content A is deleted before the retention date of job 3, it becomes impossible to refer to the content data processed by job 3.

To deal with this problem, when an output job is stored in the database 103, the retention date of the content data with the same content ID as the output job is updated. In the example of FIG. 5B, when job 3 is stored in the database 103, the retention date of content A is updated so as to coincide with the retention date of job 3. Specifically, the retention date of content A is changed from Jul. 1, 2008 to Aug. 20, 2008. This makes it possible to prevent content A stored in the database 103 earlier from being deleted earlier than the retention date of job 3 associated with content A. The method for updating the retention date will be described in detail later with reference to FIG. 8.

In this case, if the job history of an output job associated with content data is stored in the database before the retention date of the content data passes, the retention date of the content data is updated. However, if an output job which processes document data corresponding to the content data is generated after the retention date of the content data passes, the content data, which has already been deleted, cannot be referred to using the job history of the output job. Suppose, in the example of FIGS. 5A and 5B, an output job which processes document data corresponding to content A is generated only after Aug. 20, 2008. In this case, after Aug. 20, 2008, content A, which has been deleted, cannot be referred to. To avoid this situation, before content data is deleted from the database 103, it is determined whether or not any job history that will refer to the content data is possibly be generated in the future.

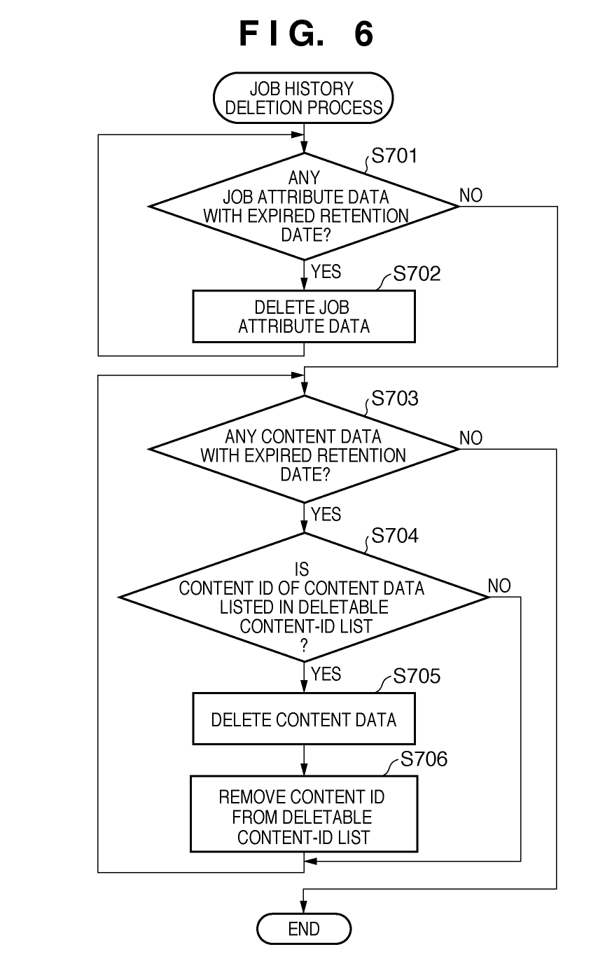

FIG. 6 is a flowchart describing a job history deletion process performed in the database 103 according to the first embodiment. The process is implemented as the CPU 221 executes a program loaded in the RAM 223. The flowchart in FIG. 6 is executed at a predetermined time (for example, once a day).

In step S701, the CPU 221 determined whether or not attribute data whose retention date has expired exists in the job histories in the database 103. If there is any job attribute data whose retention date has expired, the process advances to step S702 to delete the job attribute data. On the other hand, if there is no job attribute data whose retention date has expired, the process advances to step S703 to determine whether or not there is any content data whose retention date has expired in the job histories of the database 103. If there is no corresponding content data, the CPU 221 finishes processing. If there is the corresponding content data, the process advances to step S704 to determine whether or not the content data can be deleted, based on whether the content data is listed in a deletable content-ID list (described later). If the content data cannot be deleted, the process advances from step S704 to step S703. Otherwise, the process advances to from step S704 to step S705 to delete the content data. Then, the process advances to step S706 to remove the corresponding content ID from the deletable content-ID list. The deletable content-ID list lists the content IDs of the content data which can be deleted.

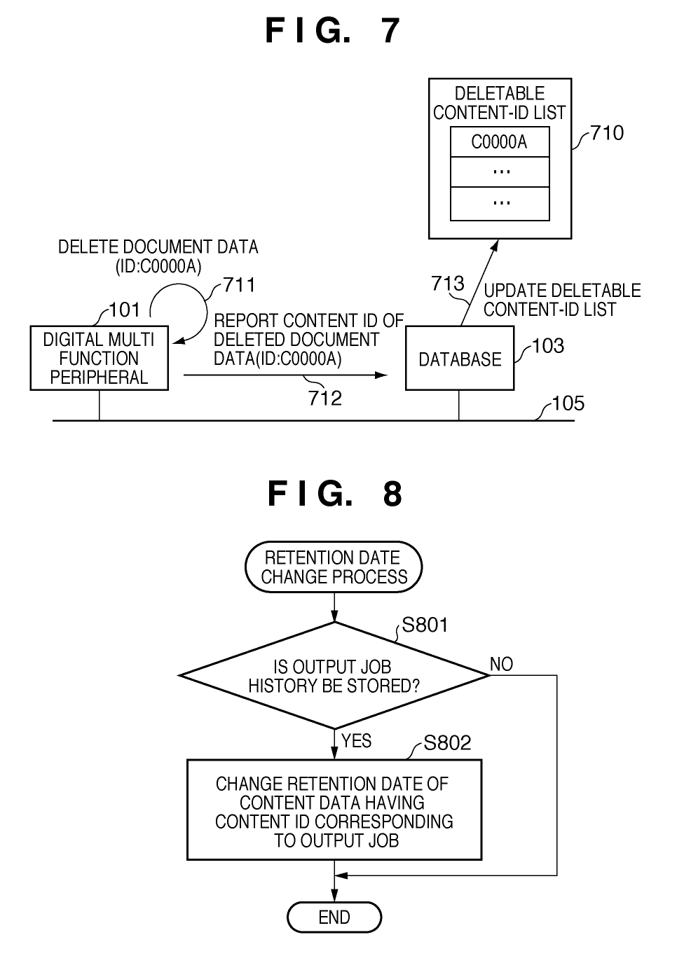

FIG. 7 is a diagram describing the processes of S704 to S706 in FIG. 6.

If document data is deleted from the box of the digital multi function peripheral 101, an output job history which refers to the content ID of the content data corresponding to the document data is no longer generated subsequently. Therefore, deletion information which indicates that the document data has been deleted is stored as a deletable content-ID list 710 in the database 103. Specifically, first the document data is deleted from the box of the digital multi function peripheral 101 (711). Accordingly, the digital multi function peripheral 101 informs the database 103 of the content ID corresponding to the deleted document data based on the attribute information of the deleted document data (712). Consequently, the database 103 holds the content ID received from the digital multi function peripheral 101 in the deletable content-ID list 710 (713). If no job history related to the content ID is stored in the database 103, there is no need to hold the content ID in the deletable content-ID list 710.

Subsequently, when a retention period of the content data corresponding to the content ID expires (passes), since the content ID is contained in the deletable content-ID list 710, the database 103 can delete the content data. On the other hand, if the retention period of the content data corresponding to the document data expires while the document data remains on the digital multi function peripheral 101 without being deleted, the database 103 does not delete the content data because the content ID of the content data is not held in the deletable content-ID list 710.

FIG. 8 is a flowchart describing the process of changing a retention date of content data in the database 103 according to the first embodiment. A program which performs this process is loaded in the RAM 223 during execution and executed under the control of the CPU 221.

The retention dates of job attribute data and content data are set when the job attribute data and content data are stored in the database 103. The retention period of the content data set in this way is changed when an output job history which refers to the content data is stored in the database 103. In step S801, the CPU 221 determines whether or not the job history to be stored is that of an output job. In the case of an output job, the process advances to step S802 to change the retention date of the content data which is stored in the database 103 and assigned the same content ID as the job history, where the retention date is changed based on the job history of the output job. For example, when the original retention date is, for example, Aug. 30, 2008, if the date on which the output job is issued is Aug. 1, 2008, the retention date is changed to Nov. 1, 2008 which comes after three months. On the other hand, if it turns out in step S801 that the job history is not that of an output job, the CPU 221 finishes processing directly.

As described above, according to the first embodiment, content data is deleted from the database only when the document data corresponding to the content data is deleted from the digital multi function peripheral 101 and the retention date of the content data expires. Consequently, the content data of an input job is not deleted from the database even if the retention date of the input job is reached before any corresponding output job is generated. This avoids the problem of not being able to refer to the content data of an input job using the job history of an output job which has a retention date later than the retention date of the input job.

A second embodiment of the present invention will be explained later. According to the second embodiment, when determining whether or not to delete content data, the database 103 asks the digital multi function peripheral 101 for confirmation. Hardware configurations of the digital multi function peripheral 101, servers 102 and 104, and database 103 according to the second embodiment are the same as in the first embodiment, and thus description thereof will be omitted.

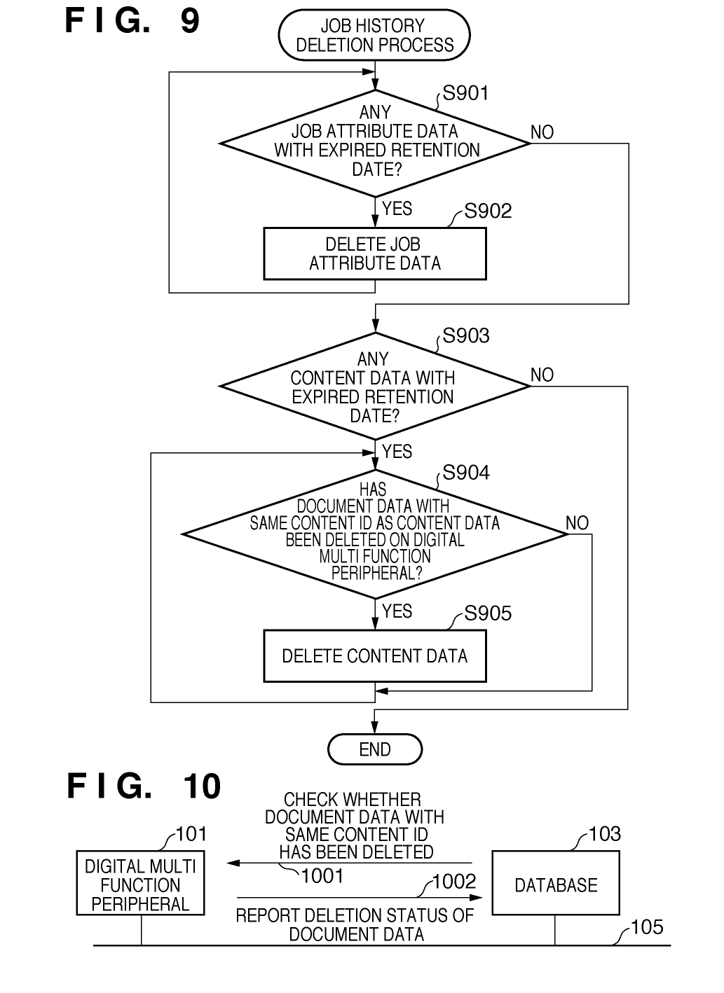

FIG. 9 is a flowchart describing a job history deletion process performed in the database 103 according to the second embodiment. The job history deletion process is implemented as the CPU 221 executes a program loaded in the RAM 223.

The flowchart in FIG. 9 differs from the flowchart in FIG. 6 according to the first embodiment in the process of step S904. In step S704 in FIG. 6, when document data is deleted on the digital multi function peripheral 101, the content ID of the content data corresponding to the document data is reported to the database 103 so that the content ID will be stored in the deletable content-ID list 710. In step S904, however, instead of storing the deletable content-ID list 710 in the database 103 as deletion information which indicates that the document data has been deleted on the digital multi function peripheral 101, the database 103 checks with the digital multi function peripheral 101 as required. Specifically, when attempting in step S904 to delete the content data in the database 103, the CPU 221 inquires of the digital multi function peripheral 101 whether or not the document data with the same content ID as the content data has been deleted on the digital multi function peripheral 101. Incidentally, the digital multi function peripheral in which the document data with the content ID is stored can be identified with reference to the attribute information of the document data. If it is determined in step S904 that the document data corresponding to the content data has been deleted, the process advances to step S905 to delete the content data. On the other hand, if it is determined in step S904 that the document data corresponding to the content data has not been deleted, the CPU 221 finishes processing without deleting the content data.

FIG. 10 is a diagram describing the content data deletion process in steps S904 and S905 in FIG. 9.

According to the first embodiment, when document data is deleted from the user box area of the digital multi function peripheral 101, deletion information to that effect is stored in the database 103. On the other hand, according to the second embodiment, when attempting to delete a job history, the database 103 inquires of the digital multi function peripheral 101 whether or not the document data corresponding to the content data has been deleted from the database 103 (1001). The digital multi function peripheral 101 informs the database 103 of deletion status which indicates whether or not the document data has been deleted (1002). The database 103 determines whether or not to delete the content data, based on the deletion status reported from the digital multi function peripheral 101.

As described above, the second embodiment provides the following advantage in addition to the advantages of the first embodiment. Specifically, deletion status information about only the content data registered in the database 103 is transmitted to the database 103 from the digital multi function peripheral 101, providing the advantage of reducing the amounts of data transmitted through the network 105.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-180049, filed Jul. 31, 2009, which is hereby incorporated by reference herein in its entirety.

What is claimed is:

1. A data processing system which enables storing content data in a database as a job history of a job executed on a data processing apparatus, the content data representing contents of data related to the job, the data processing system comprising:
a job history storage unit configured to store the content data in the database with a retention date of the content data;
a determination unit configured to determine that the content data stored in the database is deletable if data corresponding to the content data has been deleted on the data processing apparatus; and
a deletion unit configured to delete the content data determined by the determination unit to be deletable, when the retention date of the content data passes.

2. The data processing system according to claim 1, wherein the determination unit stores information indicating that the data corresponding to the content data has been deleted on the data processing apparatus and determines whether or not the content data is deletable with reference to the information.

3. The data processing system according to claim 1, wherein the determination unit determines whether or not the content data is deletable by inquiring of the data processing apparatus from the database whether the data corresponding to the content data has been deleted on the data processing apparatus.

4. The data processing system according to claim 1, further comprising a storage control unit configured to store a job history containing content data which represents contents of new data, in the database when the job executed on the data processing apparatus is an input job which involves inputting the new data, and store a job history containing reference information which refers to the content data, in the database in a case that the job executed on the data processing apparatus is an output job which outputs the data inputted by the input job.

5. The data processing system according to claim 1, further comprising a change unit configured to change the retention date of the content data stored in the database when storing a job history which refers to the content data, in the database.

6. A method of controlling a data processing system which includes a database connected with a data processing apparatus via a network and enables storing content data in the database as a job history of a job executed on the data processing apparatus, the content data representing contents of data related to the job, the control method comprising:
storing the content data with a retention date of the content data;
determining that the content data stored in the database is deletable if data serving as the basis of the content data has been deleted on the data processing apparatus; and
deleting the content data determined in the determining step to be deletable, when the retention date of the content data passes.
